(19) United States
(12) Patent Application Publication
(10) Pub. No.: US 2004/0089128 A1
(43) Pub. Date: May 13, 2004

(54) Glass score line "running" and "breaking" device

(76) Inventor: Charles Lee Watson, Brunswick, OH (US)

Correspondence Address: Charles L. Watson, 1486 Clearbrooke #120, Brunswick, OH, 44212, US

(21) Appl. No.: 10/634,949

(22) Filed: Aug. 5, 2003

Related U.S. Application Data
(60) Provisional application No. 60/401,508, filed on Aug. 7, 2002.

(51) Int. Cl. B31B 1/25

(52) U.S. Cl. 83/879

(57) ABSTRACT

This tool is intendee, but not limited, to use in the stained glass arts. By utilizeing an arangement of wheels (with applyed pressure) some prviously “not possible” breaks, or cuts, can now be made. And, as a seondary benifit very difficult breaks become simple. This is accomplished by controlling the score line “run” as the glass is pushed through the wheel arrangement system.

### CROSS-REFERENCE TO RELATED APPLICATIONS

This application claims the benifit of U.S. Provisional Applicayion Ser. No. 60/401,508 filed on Aug. 7, 2002.

### STATEMENT REGARDING FEDERALLY SPONSORED RESEARCH OR DEVELOPMENT

Not Applicable

### REFERENCE TO SEQUENCE LISTING, A TABLE, OR A COMPUTOR PROGRAM LISTING COMPACT DISC APPENDIX

Not AApplicable

### BACKGROUND OF INVENTION

In the field of “cutting” glass it is difficult and sometimes just not possible “break out” the desired shape one wants. By means of controling the “run” (or fracture) of a score line these breaks are easy and possible.

### BRIEF SUMMARY OF INVENTION

The object of this invention is four fold. First is to “run” and “break” score lines very simpley. Second is to minimize waste caused by multiple “breaks” in order to realse the desired section. The third factor is to be able to adjust for type and thickness of glass. Fourth, and probably the most important, is to be able to “break-out” the previously “not possible” breaks, such as inside right angles. All of the above is made possible by controling the “run” and the pressure applyed to the glass surface.

All of the above can be reduced down to three areas.

1. Run-out of a score line.

2. Inside curves.

3. Inside right angles.

Item 1: As the glass is passed through the machine equal pressure is applyed thus minamizing the “run” from tracking off.

Item 2: When a inside curve is to be made, the acceptable method is to make multiple scores and breaks wasteing away the interior glass. With this machine a single score can be “run” and “broken out” with a outside curve (matching the interior) remaining as usefull glass.

Item 3: Cutting and “breaking out” a right angle (inside) was just not possible because either the “run line” would continue or excess internal stress would cause the glass to crack. The problem was solved by controle of the “runn” line. Thus, one score could be ran into another produceing an inside right angle.

### BRIEF DISCRIPTION OF THE SEVERAL VIEWS OF THE DRAWINGS

FIG. 1 is an oblique view of the Glass “Running” and Breaking” machine.

FIG. 2 shows a side view. Right and left sides are the same.

FIG. 3 is the view from the front, or head-on view.

FIG. 4 shows the top, or overhead view.

### DETAILED DISCRIPTION OF THE INVENTION

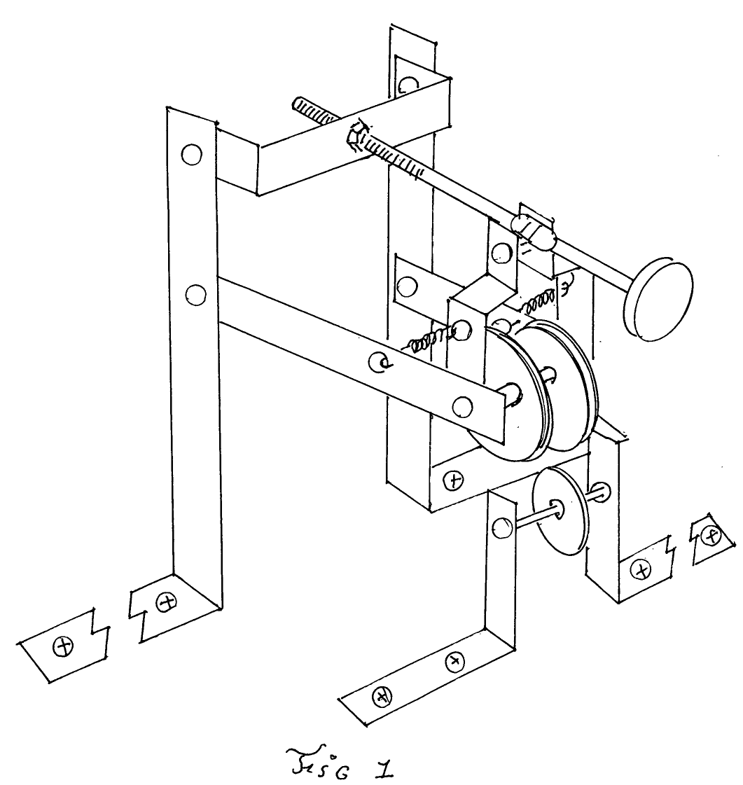

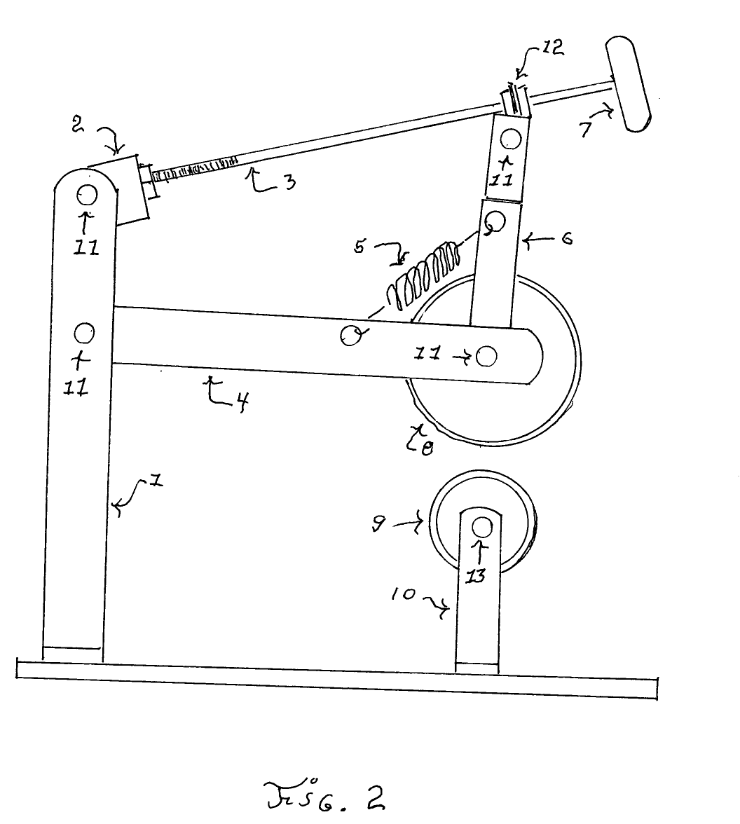

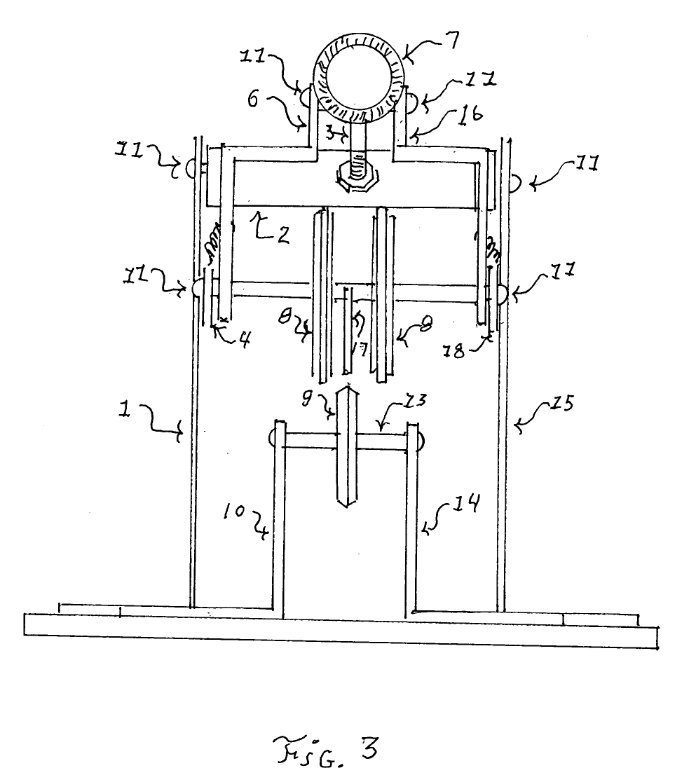

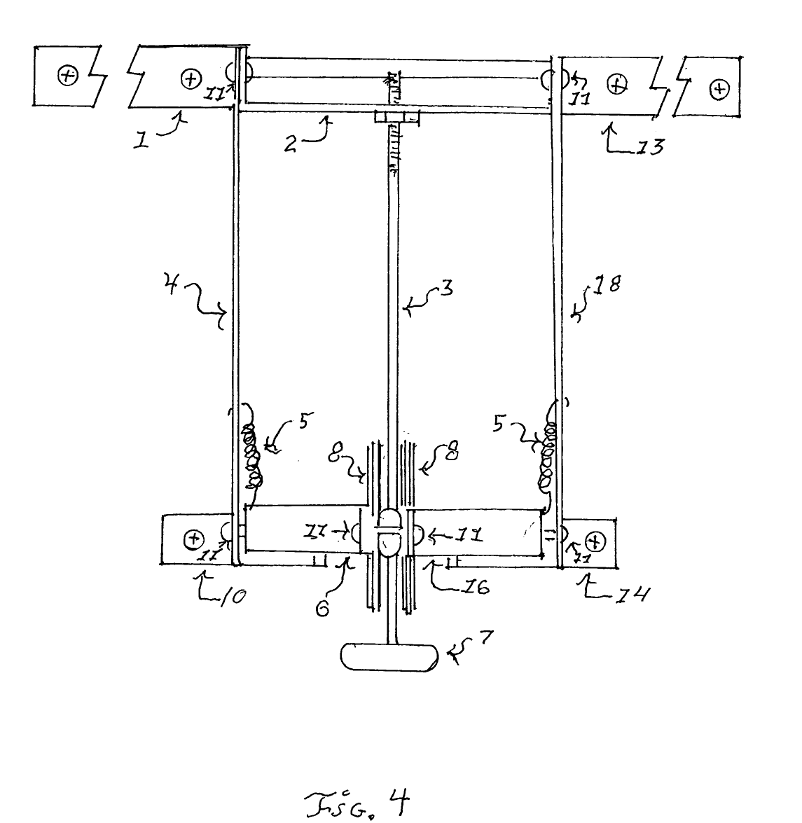

The operation of the glass running and breaking device is quite simple. By turning the adjustment knob (FIG. 1#7) downward force will be applyed to the upper wheels (FIG. 3 38 #8). The amount of pressure is determined by the springs (FIG. 4 #5). The rate of adjustment will be determined by the thread size on the adjustment rod (FIG. 4#3) engaging the fixed nut on the moveable cross brace (FIG. 4#2). This force is transered vera levers (FIG. 2#4&6). The levers are allowed to pivot on a shaft (FIG. 2#11) permitting up and downward movement, but limiting side movement. Between and below the two moveable wheels is a fixed-height rotating smaller wheel (FIG. 3#9). The height is determond by the supports (FIG. 3#10 &14) and shaft (FIG. 3#13) location. Directly above the lower wheel is an alignment indicator (FIG. 3#17). This will indicate where the score line is in relation to the lower wheel.

The device was built useing common materials. The uprights (FIG. 3#1&15) along with support levers (FIG. 4#4&18) were built useing ¾″ wide and 3/32″ thick steel. Supports (FIG. 3#10&14) cross-brace (FIG. 3#2), and upper levers (FIG. 3#6&16) were made useing 1/16″ metal. The supports and levers are ½″ wide and the cross-brace is ⅝″ wide. But, the construction may not be limited to steel. Any material that can sustain the pressures without flex or distortion could be used.

The upper wheels (FIG. 3#8) are plastic with a foam coating, to protect the glass, on the outside diameter. The lower wheel (FIG. 3#9) is plastic with a sharpened edge on the outside diametor.

The springs that supply the applyed (FIG. 4#5) force can very. This would depend on the glass and and the pressure needed. A good starting point is a 50# spring measuring 1¾″ long with a 5/16″ diameter.

Even though springs are used for this application there is no reason pneumatic, hydrolic, or any force giving device can be used.

What sets this invention apart from other methods of “running” and “reaking” glass is simple. Before this idea there were only a few ways to “run” glass. They are by useing plires type devices, by hand, or by heating and cooling the glass. None of these would let the user slowly guide the “run” along the score line. This device will allow the user to slowly cause the “run” with minimal pressure as it is pushed between the wheels.

Hoe to Use

Turn the adjusting knob putting pressure on the upper wheels. Place a scored piece of glass (score side up) between the upper wheels and the lower wheel. Align the score line with the indicator (FIG. 3#17) between the upper wheels. Push the glass along the score line and a “run” will occur. Useing the adjustment knob increase the pressure and push the glass through the wheels again and it will break along the “run” line.

1. What I claim as my invention is the idea of causeing a complete fissure in glass, and then a fracture, by means of manipulation of the forces that are required to cause the desired effect.
